(19) United States
(12) Patent Application Publication
(10) Pub. No.: US 2005/0152670 A1
(43) Pub. Date: Jul. 14, 2005

(54) Auxiliary memory in a tape cartridge

(75) Inventor: Daniel R. Skaar, Denver, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 10/758,935

(22) Filed: Jan. 14, 2004

(51) Int. Cl. H04N 5/76; H04N 5/781

(52) U.S. Cl. 386/46; 386/125

(57) ABSTRACT

A memory peripheral, such as a tape cartridge, providing primary data storage and a receptacle for one or more auxiliary memory elements is provided. The primary data storage may be a tape media or other memory media. The memory peripheral is adapted to dock with a drive and allows the drive to communicate with both the primary data storage and the auxiliary memory elements. The memory peripheral may include a contact interface, such as an optical fiber interface, for communicating between the host and the auxiliary memory element. The memory elements may be removable. The memory element may provide sufficient data storage for storage of thumbnail images and/or other compressed or abbreviated data that is derived from data stored in the primary data storage.

### BACKGROUND OF THE INVENTION

Digital data is stored in tape cartridges that include a magnetic tape media wound on a tape reel. In the art of data storage, the physical space required to store data on tape cartridges is an important concern. To conserve space, tape-handling devices, e.g., tape drives, often use a single reel tape cartridge design, which utilizes a supply reel located within a removable tape cartridge and a take-up reel located within the tape-handling device.

In addition to the tape media, tape cartridges sometimes include a memory element separate from the tape media, e.g., an integrated circuit chip, for storing information related to the cartridge and/or its contents that is more readily accessible by the tape-handling device. The communication between the tape-handling device and the memory element is primarily provided by one of two methods, namely non-contact and contact methods.

According to a first method, a non-contact interface, such as a radio frequency (“RF”) link, between the memory element and an RF device, e.g., RF transceiver, in the tape-handling device is utilized. In this case, the memory element may be read from and written to by the RF transceiver, which additionally provides power to the memory element eliminating the need for physical contact between the memory element and the transceiver. This is commonly referred to in the art as a contactless or a non-contact design.

According to a second method, the memory element is mounted to the cartridge in a manner that provides contact between one or more electrical conductors connected to the memory element and mating conductors within the tape-handling device. This is commonly referred to in the art as contact memory element design. In this case, when a cartridge including the memory element is inserted into the tape-handling device, a read/write device makes contact with the mating conductors of the memory element. The read/write device via the conductors is then able to provide power to the memory element and able to read data from and/or write data to the memory element.

Unfortunately, cartridge memory elements are fixedly mounted in the cartridge, are not changeable or upgradeable, have limited capacity, and have limited data transfer rates, thus limiting potential applications of such memory elements.

### BRIEF SUMMARY OF THE INVENTION

In some embodiments of the present invention, a data cartridge has an optical interface and one or more receptacles for holding a corresponding one or more auxiliary memory elements. Some embodiments provide a cartridge comprising: a housing adapted to dock with a storage drive; a storage media mounted in the housing; a receptacle in the housing, wherein the receptacle is adapted to removably hold an auxiliary memory element; and an optical interface adapted to provide a data path between the auxiliary memory element and the storage drive.

In some embodiments of the present invention, a data cartridge has one or more receptacles for holding a corresponding one or more auxiliary memory elements, each providing 1 MB or more of data storage. Some embodiments provide a tape cartridge comprising: a housing; a magnetic tape rotatably mounted in the housing; a receptacle in the housing, wherein the receptacle is adapted to removably hold an auxiliary memory element providing at least 1 MB of data storage; and a physical interface adapted to provide a contact path between the auxiliary memory element and a tape drive.

In some embodiments of the present invention, a peripheral memory device has an optical interface and a receptacle for communicating with and holding an auxiliary memory element. Some embodiments provide a peripheral memory device comprising: a housing adapted to removably dock with a drive; a first memory storage media in the housing, wherein the first memory storage media provides primary memory; a receptacle adapted to removably receive an auxiliary memory element providing secondary memory; an aperture in the housing adapted to provide a path for inserting and extracting the auxiliary memory element; and an optical interface adapted to provide a data communication path between the auxiliary memory element and the drive.

In some embodiments of the present invention, a tape cartridge system has a tape drive and a receptacle for holding an auxiliary memory element containing 1 MB or more of data storage. Some embodiments provide a memory storage system comprising: a cartridge having a housing; a primary memory mounted in the housing; a receptacle in the housing, wherein the receptacle is adapted to removably hold a removable memory element containing at least 1 MB of data storage; a drive adapted to removably hold the cartridge; and a data communications path between the removable memory element and the drive.

In some embodiments of the present invention, a method writes data to a tape media and writes compressed or abbreviated data to an auxiliary memory element in a tape cartridge. Some embodiments provide a method of writing data to a tape cartridge having a tape media and an auxiliary memory element, the method comprising: writing information to the tape media; transforming the information to transformed data, wherein the transformed data occupies less data storage than the information; and writing the transformed data through an optical interface to the auxiliary memory element.

In some embodiments of the present invention provide a method of using a cipher key to process data between a host and a tape cartridge having a tape media and at least one auxiliary memory element, the method comprising: reading the cipher key from the auxiliary memory element; reading data from a source; processing the data with the cipher key; and writing the processed data to a depository.

In some embodiments of the present invention provide a method for a drive to initialize a cartridge without instructions from a host, wherein the cartridge has a storage media and an auxiliary memory element, the method comprising: providing a drive coupled to the host; inserting the cartridge into the drive; detecting the cartridge in the drive; detecting the auxiliary memory element in the cartridge; and transferring data between the auxiliary memory element and the storage media.

In some embodiments of the present invention provide a cartridge having an optical interface comprising: an insulator; a first electrically conductor and a second electrical conductor, wherein the conductors are electrically isolated by the insulator and adapted to provide power; and an optical interface adapted to provide a data path.

In some embodiments of the present invention provide a drive comprising: a receptacle, wherein the receptacle is adapted to removably hold a cartridge having a storage media and one or more auxiliary memory elements; a first data interface to read data from and write data to the storage media; a second data interface to read data from and write data to the one or more auxiliary memory elements, wherein the second data interface is an optical interface; circuitry to detect a presence of the one or more auxiliary memory elements.

### BRIEF DESCRIPTION OF THE DRAWINGS

FIG. 1 depicts a tape cartridge having an auxiliary memory element operating with a tape drive in accordance with the present invention.

FIG. 2 illustrates a perspective view of tape cartridge having a receptacle for an auxiliary memory element in accordance with the present invention.

FIG. 3 illustrates a top view of tape cartridge having an auxiliary memory element in accordance with the present invention.

FIG. 4 shows a block diagram illustrating a wireless interface between an auxiliary memory element in a tape cartridge and a tape drive in accordance with the present invention.

FIG. 5 shows a diagram of a contact interface between an auxiliary memory element in a tape cartridge and a tape drive in accordance with the present invention.

FIG. 6 shows a diagram of a contact interface between multiple auxiliary memory elements in a tape cartridge and a tape drive in accordance with the present invention.

FIG. 7 illustrates a perspective view of tape cartridge for housing an auxiliary memory element in accordance with the present invention.

FIG. 8 illustrates a perspective view of tape cartridge for housing two auxiliary memory elements in accordance with the present invention.

FIG. 9 illustrates a perspective view of tape cartridge for housing multiple auxiliary memory elements in accordance with the present invention.

FIG. 10 illustrates a perspective view of tape cartridge providing a contact connection to an auxiliary memory element in accordance with the present invention.

FIG. 11 illustrates a perspective view of an optical fiber interface in accordance with the present invention.

FIG. 12 shows a data structure of exemplary data stored in an auxiliary memory element in accordance with the present invention.

### DETAILED DESCRIPTION OF THE INVENTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the appended claims.

Memory elements incorporated into tape cartridges and tape cassettes have been described. See for example, U.S. patent application Ser. No. 10/189,810 entitled “Replaceable Memory Element in a Single Reel Tape Cartridge” (herein incorporated by reference in its entirety) and U.S. patent application Ser. No. 10/189,158 entitled “Repositionable Memory Element in a Single Reel Tape Cartridge” (herein incorporated by reference in its entirety), both filed on Jul. 03, 2002. Some systems, however, only provide an auxiliary memory element having limited data capacity, for example, a few bytes of memory to a few kilobytes of memory. Such limited data capacity is available to store binary flag and ASCII textual information.

### Tape Handling System

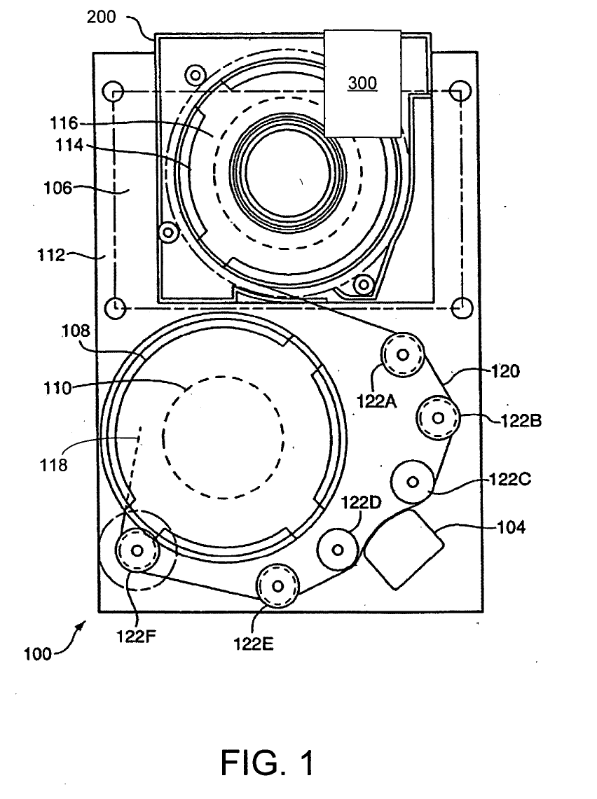

FIG. 1 depicts an example of a tape-handling device, namely tape drive 100, for use with a tape cartridge, namely tape cartridge 200, having an auxiliary memory element, namely memory element 300, according to the present invention. The tape drive 100 includes a tape head 104, a tape cartridge receiver 106, and an internal take-up reel 108 driven by a take-up reel drive motor 110. These elements are contained within a housing, typically including a base 112 and top cover portion (not shown). The tape cartridge 200 includes a supply reel 114 having magnetic tape media 116 spooled thereon. The tape media 116 is of a predetermined particular type and is provided to the tape drive 100 by insertion of the tape cartridge 200 into the cartridge receiver 106. After insertion of the tape cartridge 200, an automatic loading process is performed in the tape drive 100. The loading process is representative of connecting, e.g. through a buckle connection, a tape cartridge leader 118, connected to the tape media 116, and a take-up leader 120, connected to the take-up reel 108. After connection of the tape cartridge leader 118 and take-up leader 120, the tape media 116 is spooled off of the cartridge supply reel 114 onto the take-up reel 108 via the tape path defined by guide rollers 122A-F.

### Tape Cartridge Having Removably Held Memory Element

Some embodiments of the present invention provide a tape cartridge adapted to removably hold an auxiliary memory element. By allowing the auxiliary memory element to be removable, a customer may upgrade a tape cartridge in the field and an operator may remove the auxiliary memory element to access the data without using a tape drive. Additionally, by providing a tape cartridge with a removable memory element, a customer may store encryption and/or access and permission information on the removable memory element. The removable memory element may be inserted when access or encryption/decryption of the data is necessary. The removable memory element is more compact than the tape cartridge; therefore the removable memory element may be more securely stored and more easily transported.

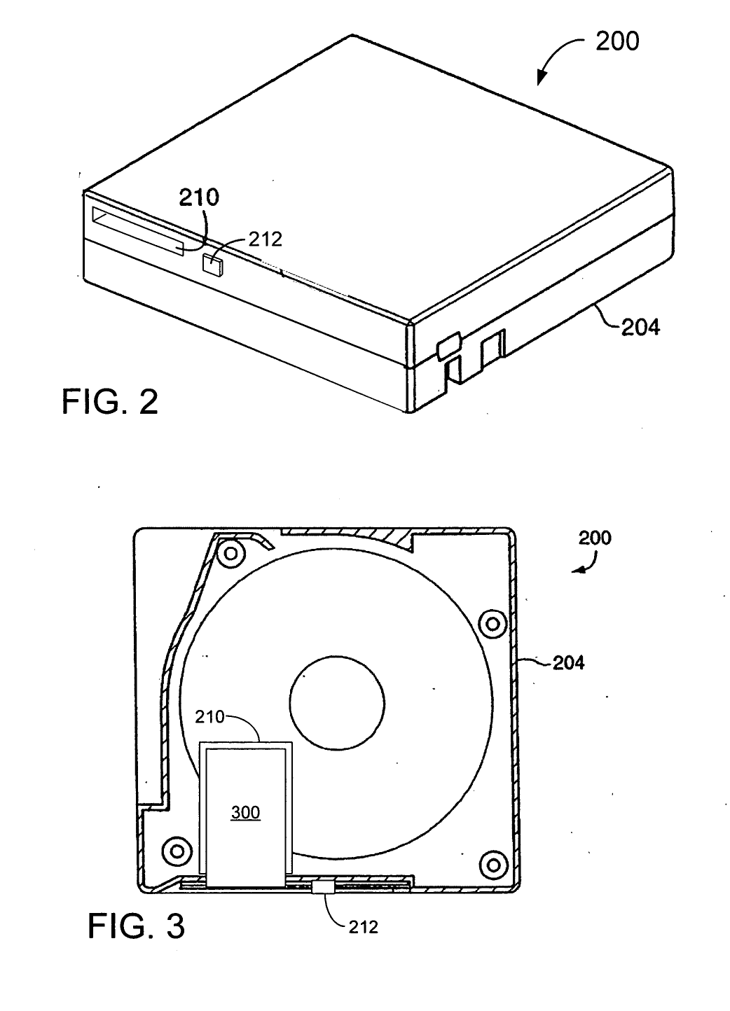

Referring to FIGS. 2 and 3, there is shown an embodiment of the tape cartridge 200, namely tape cartridge 200 including an auxiliary memory element 300. In this example of the present invention, the memory element 300 is removable and housed internally to the cartridge housing 204 of the tape cartridge 200. The memory element 300 may be internally mounted at any appropriate location in the tape cartridge 200 to provide an exchange of information with a tape-handling device, such as tape drive 100. The exchange of information may be made by an RF connection, an inductive connection, a conductive connection, or an optical connection. An optical connection may be made by a physical or connection interface, such as with an optical fiber, or may be made by a connectionless interface, such as with an infrared (“IR”) connection.

In some exemplary embodiments, an aperture and a receptacle 210 in the tape cartridge housing 204 holds a memory element 300 of a predetermined geometry. The memory element 300 removably fits into the aperture and receptacle 210. In this regard, the memory element 300 is constructed in dimensions that permit insertion and extraction of the memory element 300 into the receptacle 210. For example, the memory element 300 may slide into place so that the memory element 300 is removably secured at least substantially within tape cartridge housing 204.

FIG. 3 illustrates a top view of a tape cartridge 200 including an aperture and a receptacle 210 for removably holding the memory element 300. A receptacle 210 removably held in a tape cartridge 200 allows the memory element 300 to be removed from the tape cartridge 300 without disassembly. Advantageously, the inclusion of the memory element 300 in the receptacle 210 does not significantly alter the outer dimensions of the tape cartridge housing 204. In some embodiments, the auxiliary memory element 300 is removable and/or ejectable from the tape cartridge 200 without disassembly of the tape cartridge 200. For example, the memory element 300 may be removed by depressing an eject button 212 or the like and sliding the memory element 300 out of the receptacle 210.

Still yet another advantage of some embodiments of the present invention is that tape cartridges, such as tape cartridge 200, a memory element 300 may be installed at any point in time. In other words, the memory element 300 may be included in the tape cartridge 200 by the cartridge manufacturer at the time of manufacturing, or subsequently added to the tape cartridge 200 at a later date by the manufacturer or a customer. Additionally, one memory element 300 may be removed and replaced with a different memory element 300, such as a memory element having a greater data capacity. Those skilled in the art will appreciate the significant benefit this provides in relation to the quantity of tape cartridges on the market that do not include a memory element, but that could be easily installed according to the principles of the present invention.

The removable mounting of an auxiliary memory element 300, as provided by some embodiments, provides the additional advantage of upgrade ability and field installation of the memory element 300. Furthermore, the ejectability or removability of the memory element 300 provides a significant advantage in that it is easily removed and replaced in the event of damage without destruction or disassembly of the tape cartridge 200.

Additionally, the removable mounting of the memory element 300 provides for recycling of memory elements 300 without dismantling the tape cartridge 200. Some tape cartridges 200 have a predicted mean-time before failure (MTBF), for example, of approximately 250,000 hours. When a tape cartridge 200 has reached this time or a predetermined fraction of this time, the tape cartridge 200 may be scheduled for replacement. When a tape cartridge 200 reaches the end of its useful life, for example, because of scheduled replacement or detection of excessive signs of wear, the memory element 300 may be removed from the old tape cartridge 200 before it is discarded, destroyed or recycled. Some applications may require that the data in the memory element 300 be preserved. Other applications may require that the data in the memory element 300 be erased. Still other applications may require that some of the data in the memory element 300 be modified and/or erased. A new or refurbished auxiliary memory element 300 may then be inserted into a new tape cartridge 200.

### Tape Cartridge Having a Data Interface

Some embodiments of the present invention provide a physical interface between a tape drive and an auxiliary memory element. In some embodiments, the physical interface is provided by an optical interface. Some embodiments of the present invention provide a data cartridge having an optical interface and multiple receptacles, each for holding a corresponding auxiliary memory element. A receptacle may be positioned within a data cartridge in a location otherwise not functional, thereby utilizing empty space in the tape cartridge.

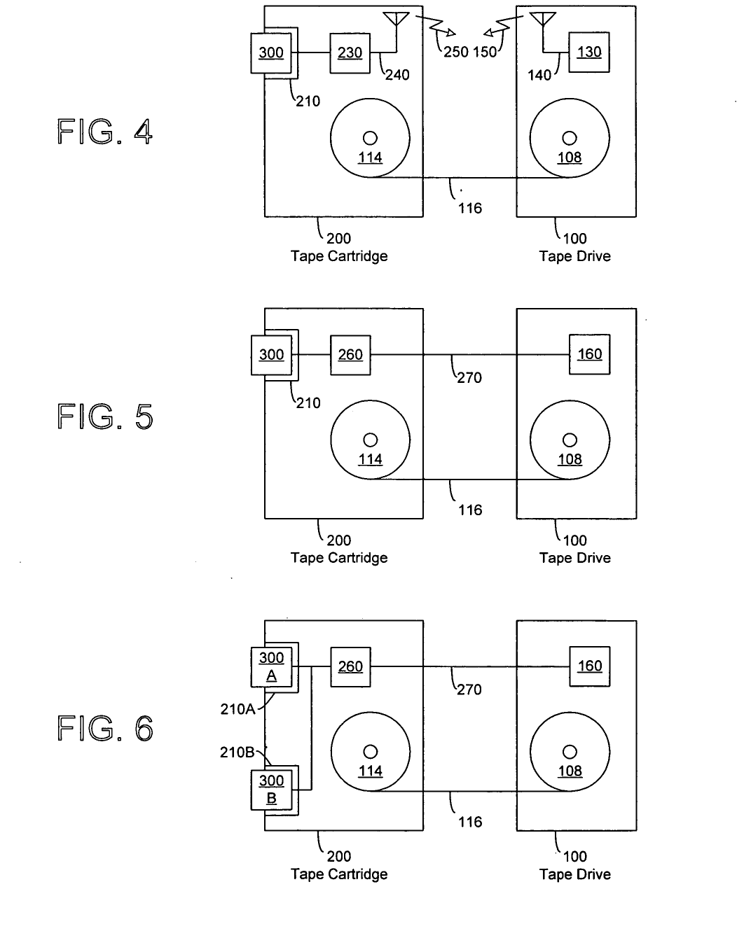

Referring to FIGS. 4-6, there is shown interfaces between one or more auxiliary memory elements 300 and a tape drive 100 in accordance with some embodiments of the present invention. To exchange information with a tape-handling device, such as the tape drive 100, the memory element 300 couples to the tape-handling device using either a non-contact interface, such as an RF antenna/transceiver or an optical infrared interface, or a contact interface such as an electrical or optical fiber interface. Additionally, power may be delivered from the tape drive 100 to the memory element 300 either wirelessly or by conductors. The tape cartridge 200 includes a supply reel 114 having magnetic tape media 116 spooled thereon. The tape drive 100 includes an internal take-up reel 108 driven by a take-up reel drive motor. The tape cartridge 200 further includes at least one receptacle 210 for accepting and holding an auxiliary memory element 300.

Some embodiments of the present invention further include a non-contact interface for communicating data wirelessly, for example, by using a transceiver 230 and an antenna 240, or by an optical transceiver such as an infrared transceiver. In some embodiments, a transceiver 230 and/or an antenna 240 are integrated into the memory element 300. In other embodiments, a transceiver 230 and an antenna 240 are both integrated into the tape cartridge 200.

FIG. 4 illustrates a tape cartridge 200 having a transceiver 230 and an antenna 240 integrated into the tape cartridge 200. A corresponding tape drive 100 also includes a transceiver 130 and an antenna 140. The transceivers 130, 230 and antennas 140, 240 provide a non-contact interface between an auxiliary memory element 300 and a tape drive 100. The transceiver 130 in the tape drive 100 transmits signals 150 by way of its antenna 140. The transceiver 230 in the tape cartridge 200 receives these signals 150 through its antenna 240. Similarly, the transceiver 230 in the tape cartridge 200 transmits signals 250 by way of its antenna 240. In turn, the transceiver 130 in the tape drive 100 receives these signals 250 through its antenna 140. A non-contract interface may also be provided by an optical interface, such as by an infrared interface.

The transceiver 230 may be a radio frequency transceiver including radio frequency circuitry that utilizes a plurality of conductive paths formed as circuit windings on a surface of a substrate. In this regard, the memory element 300 may utilize the windings of the antenna 240 and the transceiver 230 to perform radio frequency power transfer and data communication with a mating antenna 140 and transceiver 130 in the tape drive 100, without physical contact between the transceivers 130 and 230. More particularly, when the tape cartridge 200 is inserted into the tape drive 100, an antenna 240, located in either the memory element 300 or the tape cartridge 200, is positioned adjacent a mating antenna 140 in the tape drive 100. The antenna 140 in the tape drive 100 comprises the primary windings of a transformer, while the antenna 240 in the tape cartridge 200 comprises the secondary windings of the transformer. The transformer inductively exchanges signals, including data signals and power signals, between the memory element 300 and the tape drive 100 using transceivers 130 and 230.

For example, when the transceiver 130 and the antenna 140 of the tape drive 100 induces a signal 150 into the windings of the antenna 240, the windings deliver a signal indicative of the signal 150 through transceiver 230 to the memory element 300. A rectifier in the transceiver 230 may be used to acquire power from the carrier of the transmitted signal 150. The signal 150 may also carry a data signal, which may be detectable by processing circuitry within the transceiver 230. The signal 150 may be used to write data to the memory element 300 or initiate a read of data from the memory element 300. In response, transceiver 230 and antenna 240 may induce a signal 250 on the antenna 140 and the transceiver 130 of the tape drive 100. The signal 250 is similarly detectable by processing circuitry within the transceiver 130 of the tape drive 100. The transceiver 230 may be configured to allow both reading from and writing to the memory element 300. Alternatively, the transceiver 230 may be configured to allow just reading from or just writing to the memory element 300.

In the embodiments described above, both power and data are supplied to the transceiver 230 and the memory element 300 wirelessly. In other embodiments, power is supplied by a contact connection and data is supplied wirelessly. In other embodiments, power is supplied by a battery in the tape cartridge 200 or in the memory element 300. Still in other embodiments, data is supplied by a contact connection and power is supplied inductively. In additional embodiments, both power and data are supplied by one or more contact connections between the tape drive 100 and the tape cartridge 200. A contact connection is a physical connection that provides conductive and/or optical fiber paths, thereby allowing transfer of a higher level of power and allowing greater throughput during data transfer. A physical connection may include an electrically conductive connection, such as provided by a copper wire or other conductor. A physical connection may include an optical fiber connection, such as provided by coaxial optical fiber.

FIG. 5 illustrates a tape cartridge 200 that also includes physical interface electronics 260. A corresponding tape drive 100 includes physical interface electronics 160. The interface electronics 160, 260 provide a physical connection 270 between the auxiliary memory element 300 and a tape drive 100. The physical connection 270 may be provided conductively with one or more electrical conductors or optically with an optical fiber.

The interface electronics 160 in the tape drive 100 transmit signals on a physical connection 270 to the tape cartridge 200. The interface electronics 260 in the tape cartridge 200 receive and process the signals transmitted through the physical connection 270. Similarly, the interface electronics 260 in the tape cartridge 200 may transmit signals through the physical connection 270. In turn, the interface electronics 160 in the tape drive 100 receive and process these signals sent by the interface electronics 260.

### Tape Cartridge Having Multiple Auxiliary Memory Elements

FIG. 6 illustrates a tape cartridge 200 that includes physical interface electronics 260 and multiple receptacles 210 for holding auxiliary memory elements 300. A first receptacle 210A is adapted to hold a first memory element 300A. A second receptacle 210B is adapted to hold a second memory element 300B. A corresponding tape drive 100 includes physical interface electronics 160 and a physical connection 270 modified for use with multiple auxiliary memory elements, namely memory elements 300A and 300B.

Multiple auxiliary memory elements allow the implementation of additional features not practical with only a single auxiliary memory element. For example, multiple read/write memory elements may serve and appear as a redundant array of independent disks (RAID). Additionally, one or more auxiliary memory elements may provide read-only capabilities while other auxiliary memory elements may provide both read and write capabilities.

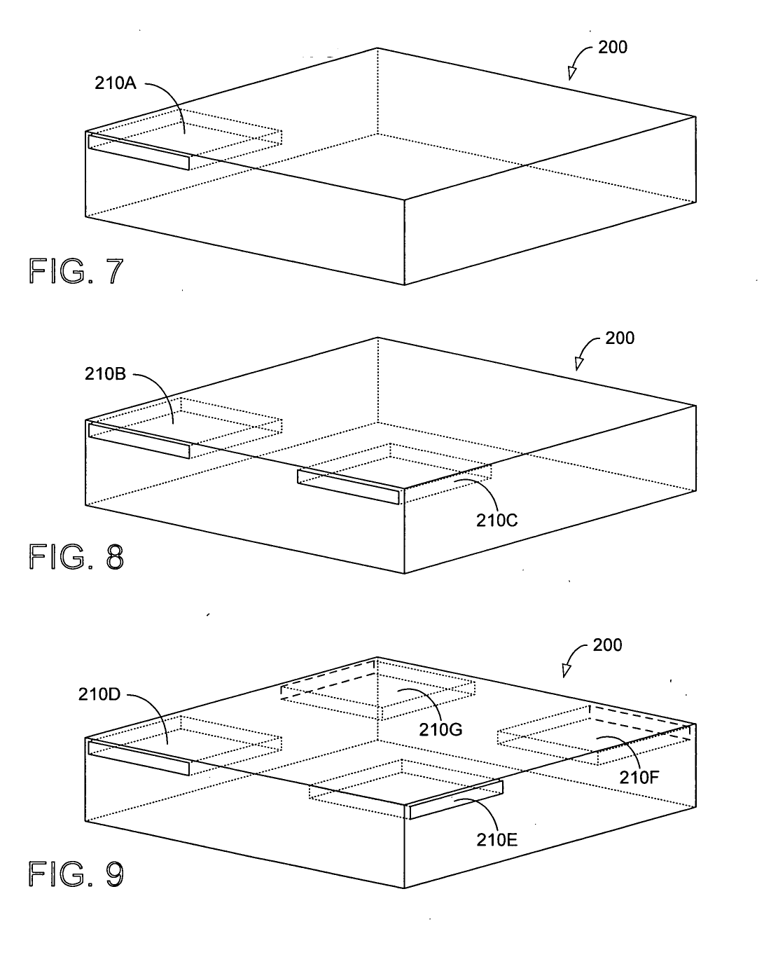

FIGS. 7-9 show embodiments of tape cartridges, namely tape cartridge 200, having one or more memory element receptacles, namely receptacles 200A-G, for holding one or more auxiliary memory elements 300. A memory element 300 may be removably mountable in a receptacle 210, whereby it is at least substantially within the housing of the tape cartridge 200. In this regard, the receptacle 210 may be mounted at any appropriate location in the tape cartridge housing that provides access to the memory element 300 without destruction or disassembly of the tape cartridge 200. Appropriate locations for a receptacle 210 include locations in which normal tape related operations of a tape cartridge 200 are not otherwise effected. Appropriate locations include locations that will not interfere with mechanics of a tape cartridge 200 insertion and extraction, as well as, locations that will not interfere with tape media mechanical movement and storage. Appropriate locations may be on the front face, sides and back face of the tape cartridge 200. Appropriate locations may also include the top side, bottom side and edges of the tape cartridge 200.

FIG. 7 shows an exemplary embodiment having a single aperture and receptacle 210 for removably mounting a single auxiliary memory element 300. The position of the receptacle 210 may be selected anywhere within the housing of the tape cartridge 200 that would otherwise be empty or non-functional space. By incorporating an auxiliary memory element 300, previously unused space within the tape cartridge 200 is better utilized.

FIG. 8 shows an exemplary embodiment of a tape cartridge 200 having two receptacles 210B, 210C for removably mounting two auxiliary memory elements 300. The receptacles 210B, 210C may be positioned on the front face. Alternatively, the receptacles 210B, 210C may be positioned on one of the sides or back faces of the tape cartridge 200. Additionally, the receptacles 210B, 210C may be positioned on the same plane, as shown, or alternatively, they may be positioned on different planes, such as directly above and below each other.

As shown in FIG. 9, multiple memory elements 300 may be removably mounted in a tape cartridge 200 having multiple apertures and receptacles, for example receptacles 210D-G. As shown, the front and back faces as well as the sides each have an aperture to a receptacle 210D-G. Alternatively, the apertures to the plurality of receptacles 210D-G may be concentrated on one or more of the faces and/or sides rather than distributed among the various sides and faces of the tape cartridge 200.

An auxiliary memory element may a readable/writable memory element, such as a flash card or a mini-hard drive. Alternatively, an auxiliary memory element may be a read-only device, such as a mini-CD-ROM disk or an optical disk. Some embodiments of the current invention provide for an auxiliary memory element 300 that is a read/write memory element, such as a solid state memory, magnetic memory or optical memory device. Some embodiments of the current invention provide for an auxiliary memory element 300 that is a read-only memory element, such as a solid state read-only memory, magnetic read-only memory or optical read-only memory. Solid date memory includes, for example ROMs, PROMs, EPROMs, EEPROMs (flash), RAM, DRAM, SRAM and SDRAM. Magnetic memory includes, for example, magnetic disks and magnetic hard drive memory. Optical memory includes, for example, optical disks and CD-ROMs.

Furthermore, an auxiliary memory element 300 may provide non-volatile storage, whereby the contents of the memory persist after power is removed from the memory element 300. For example, a flash device and a hard drive each provide non-volatile storage. Alternatively, an auxiliary memory element 300 may provide volatile storage, such that contents of memory are lost once power is removed from the memory element 300. For example, a RAM, such as a DRAM or an SDRAM, loses its contents once power is cut from the device.

An auxiliary memory element 300 may include standard off-the-shelf removably mountable memory commonly available from consumer electronic stores and vendors. For example, a receptacle 210 may be designed for a flash memory card or similar digital storage media used in consumer electronic devices such as digital cameras, digital video recorders, MP3 players, personal digital assistants (PDAs), and mobile phones.

Removable flash memory devices include devices commonly referred to as CompactFlash (CF), SmartMedia (SM), Memory Stick (MS), MultiMediaCard (MMC), Secure Digital (SD) and xD-Picture (xD) memory cards manufactured by Lexar Media, Toshiba, FujiFilm, SanDisk and other consumer memory card and memory stick manufactures. These memory elements may provide from a few megabytes to 2 gigabytes or more of available data storage.

Alternatively, a receptacle 210 may be mechanically and electrically designed to hold and communicate with a standard type I or type II PCMCIA PC card. Standard PCMCIA cards include flash data cards and mini-hard drive cards. Alternatively, a receptacle 210 may be designed for a standard mini-disk or other removable memory element.

Removable mini-disk devices include micro hard drives, for example, the Microdrive, the Hummingbird drive and the like, manufactured by companies such as Hitachi and IBM. These auxiliary memory elements may provide up to 4 gigabytes or more of available data storage space.

Tape media provides a very inexpensive media to store vast amounts of data. Tape cartridges often include tape media, which acts as data storage for storing this vast amount of data. The data may include several hundred gigabytes or several terabytes of data, for example, data retrieved while backing up a network of computer servers. Supplementing the tape cartridge with an auxiliary memory element, such as a permanent memory element or removable memory element, allows a tape drive to store additional data in a tape cartridge. The additional data stored to the auxiliary memory element may be characteristic of the use of the tape media. For example, the additional data may identify the number of hours and minutes the tape media has been in motion. The additional data may simply be a flag indicated whether the tape media is empty of data. The additional data may include data characteristic of the actual data stored on the tape media. For example, the additional data may include a directory of files stored on the tape media. For each file, the directory may include the file name and size, the date the file was written to the tape, the date the file was last accessed, and the location of the file on the tape media. Such additional data may require more than a few bytes to a few kilobytes of data storage space in the auxiliary memory element.

The use of commercially available removable memory elements, such as flash memory cards and mini-disks, advantageously allows an operator to access and modify data on the memory separately from a tape cartridge 200 and a tape drive 100. An operator may eject or similarly remove a memory element from a tape cartridge and insert the memory element into a commercially available reader, such as SanDisk's 6-in-1 ImageMate USB reader or the like. Using the separate data card reader, an operator may perform various tasks. For example, the operator may read data from the memory element and/or write data to the memory element using the reader. The operator may modify, erase and/or add data to the memory element 300. The operator may backup data from memory element 300, for example, by copying an image of the data from the old memory element 300 to a new memory element 300 having faster and/or more memory.

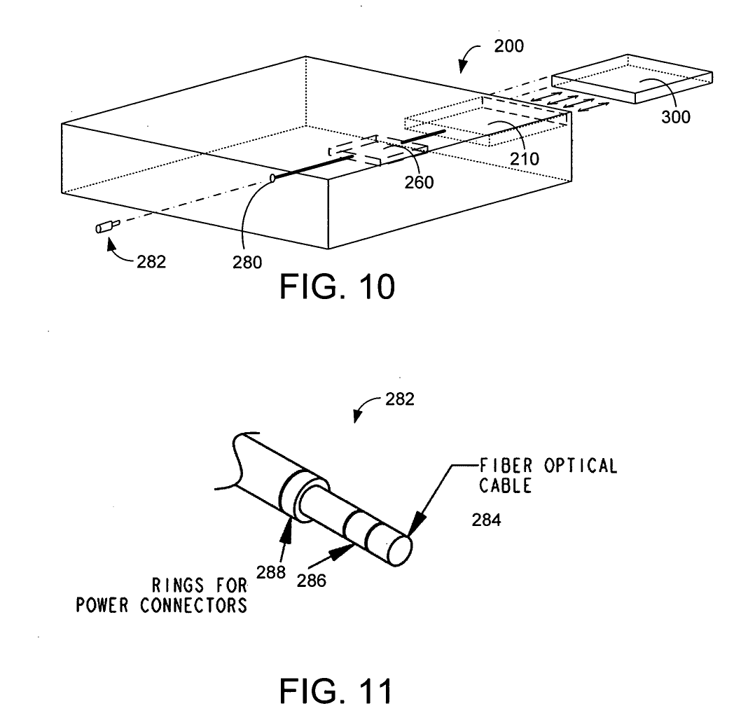

As shown in FIG. 10, a tape cartridge 200 may provide a physical connection 280 to an auxiliary memory element 300. A physical connector 280 may provide a physical connection for data as well as a path for supplying power to both the interface electronics 260 and a memory element 300 removably positioned in a receptacle 210.

In some embodiments, the physical connector 280 mates with a complementary connector 282 on a tape drive 100. The pair of physical connectors 280, 282 may include electrical conductors. For example, the interface between a tape cartridge 200 and a tape drive 100 may include conductive pogo pins, conductive pads and/or the like. In some embodiments, the pair of physical connectors 280, 282 provides an optical fiber interface for communicating data. In other embodiments, the pair of physical connectors 280, 282 provides a bi-directional LED interface for communicating data.

In some embodiments, both data and power are provided through a single connection. For example, a pair of outer coaxial rings of the connection 280 may provide a power connection and an inner core may provide an optical fiber for data communications. In other embodiments, a wired connection 280 is provided by a set of pogo pin contacts, for example, by a multi-pin connector. In still other embodiments, a data connection is provided by a first connector and a power connection is provided by a second connector.

As shown in FIG. 11, a physical connector 282 may be used to connect both data and power between a tape cartridge 200 and a tape drive 100. For example, a physical connector 282 may provide a connection for a coaxial optical fiber. The physical connector 282 may included an inner core having an optical fiber element for data and outer electrically conductive ring elements for power. In some embodiments, the physical connector 282 includes an inner element such an optical fiber 284. A first electrically conducting ring 286 and a second electrically conducting ring 288, which are insulating from each other, form outer electrically conductive elements surrounding the optical fiber 284 and provide a path for power.

### Auxiliary Memory Element Data Transfer Without Host Intervention

In some embodiments, a tape drive 100 may write data between a magnetic tape media 116 and an auxiliary memory element 300 without host intervention. The tape cartridge 200 may include both a tape media 116 and an auxiliary memory element 300. The tape cartridge 200 may be inserted into the tape drive 100. The tape drive 100 the loads the tape media 116 and prepares for data read and/or data write operations. The tape drive 100 may then automatically write data to the tape media 116 and/or to auxiliary memory element 300. Alternatively, the tape drive 100 may seek instructions on either the tape media 116 or the auxiliary memory element 300 that instruct the tape drive 100 to perform a read/write operation.

For example, the tape drive 100 may detect the existence of the auxiliary memory element 300 and automatically write information to the tape media 116. The information may be information retrieved from the auxiliary memory element 300, the tape drive 100 and/or the host.

Alternatively, the tape drive 100 may detect an instruction or set of instructions from information stored in the auxiliary memory element 300. For example, the instructions may command the tape drive 100 to transfer data from the tape media 116 to the auxiliary memory element 300. Alternatively, the instructions may command the tape drive 100 to transfer data from the auxiliary memory element 300 to the tape media 116.

In some embodiments, a tape drive 100 may write data to the auxiliary memory element 300 without host intervention during a host-to-tape read/write operation. For example, when the host instructs the tape drive 100 to write data from the host to the tape media 116, the tape drive 100 may, independently and without instruction from the host, write data, such as thumbnail or indexing data, to the auxiliary memory element 300. Additionally, when the host instructs the tape drive 100 to write data from the host to the tape media 116, the tape drive 100 may read an encryption key or ciphering information before encrypting the data and writing the encrypted data to the tape media 116. Similarly, when the host instructs the tape drive 100 to read data from the tape media 116, the tape drive 100 may read an encryption key or ciphering information before decrypting the data and providing the decrypted data to the host.

### Applications for Auxiliary Memory Elements

Memory in the auxiliary memory element 300 may be used for purposes independent of operations related to the tape cartridge 200. Alternatively or additionally, the memory in the auxiliary memory element 300 may be used for purposes relating to the data and/or the media associated with the tape cartridge 200. For example, a tape drive 100 may use the memory element 300 as an overflow buffer, for example, to temporarily hold data to be written to or read from the tape media. The memory element may be used as a cache buffer, for example, to store a copy of portions of data on the tape media, for example that may be expected to be accessed in the near future.

Some embodiments of the present invention provide a tape cartridge having a receptacle for receiving an auxiliary memory element having more than 1 megabyte of data storage. An auxiliary memory element having more that a few hundred kilobytes, such as 1 MB, 10 MB, 100 MB or more, allows for storage of more than just binary data in the form of flags and ASCII text. Supplementing a tape cartridge with an auxiliary memory element having a megabyte or more of available data storage space allows a tape drive to store new categories of data. An auxiliary memory element having a megabyte of available data storage may be used to store various identifying characteristics of the data stored on the tape media. For example, the auxiliary memory element could hold thumbnail images of images stored on the tape media. The auxiliary memory element could hold a storyboard of images or a storyboard of thumbnail images of a video file stored on the tape media. The auxiliary memory element could hold a few seconds of audio or compressed audio from of a several minute audio file stored on the tape media. By providing compressed or abbreviated versions in the auxiliary memory element of data stored on the tape media, an operator may more quickly inventory data stored on the tape media without necessarily loading the data from the tape media.

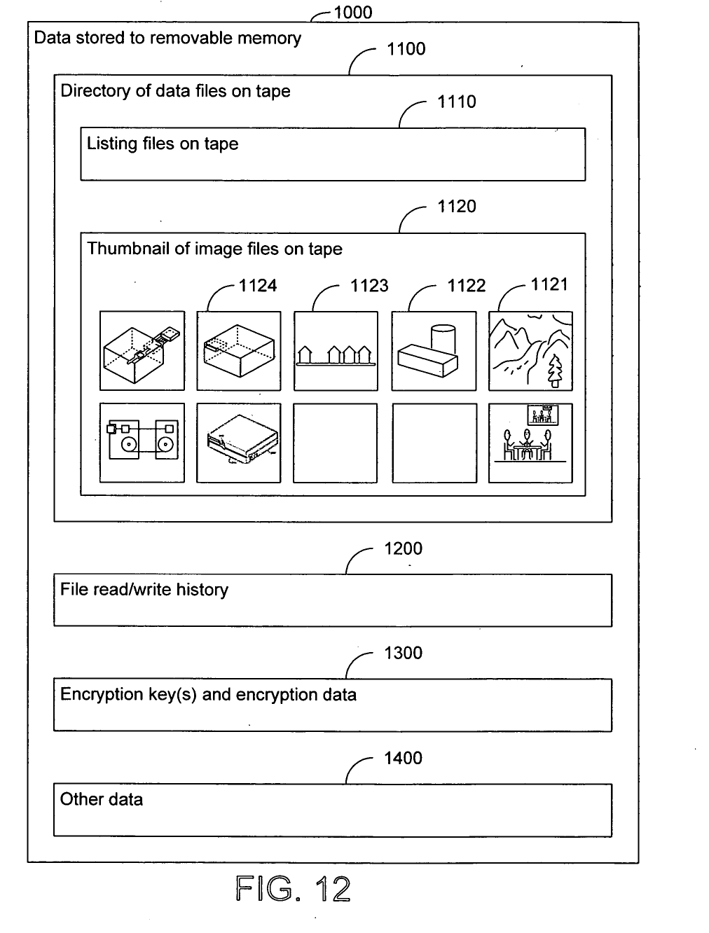

As shown in FIG. 12, memory 1000 in the auxiliary memory element 300 may be used for storing a variety of data types 1100-1400. An operator may quickly access the memory 1000 to obtain abbreviated or compressed information about data stored on the tape media. For example, the memory 1000 may include a directory or listing 1100 of files currently stored on the tape media. The memory may include a directory 1120 containing audio and/or video representations of audio and/or video files stored on the tape media. For example, the memory may include a directory 1120 containing respective thumbnail images 1121-1124 of full images stored on the tape media. A thumbnail directory or directories 1120 may contain one or more thumbnail images representative of a video stored on the tape media. The directory 1120 may contain shortened audio files that represent audio files stored on the tape media. By providing an abbreviated or a compressed version on the auxiliary memory element 300 of audio or video data on the tape media, an operator may more quickly scan, inventory or survey audiovisual data stored on the tape media.

The memory 1000 may include a history 1200 of data read from and/or written to the tape media. The memory 1000 may include encryption key(s) and encryption related data 1300. The memory 1000 of a first auxiliary memory element 300 may include a first of two cipher keys and the memory 1000 of a second auxiliary memory element 300 may include a second of two cipher keys. Having cipher keys split between two separate auxiliary memory elements 300 may enhance security by allowing keys to keep separate from each other until needed to encrypt and/or decrypt data.

The memory 1000 may include other data 1400, for example, metadata and/or data types defined by the system and/or the operator. For example, the other data 1400 may include permissions of which operators or what systems have rights to access data stored on the memory element and/or the tape media. The other data 1400 may indicate what data is sensitive or may indicate a level of security of data stored on the tape media. The other data 1400 may include a number of times a cartridge having an auxiliary memory element 300 was inserted into a drive 100.

With respect to all of the above embodiments including an auxiliary memory element 300, it will be appreciated that data stored in the memory element may also be duplicated on the tape media to facilitate recovery in the event of damage to the memory element. Such data may or may not be accessible during normal cartridge operation, but may be accessible in the event that the memory element is removed and/or replaced with a new memory element.

A further advantage may be provided by storing a duplicated copy of data stored in the auxiliary memory element 300 on the tape media in that such data may be retrievable from both the media and the memory element 300 such that the tape cartridge 200 operates with or without the memory element 300. Furthermore, it will be appreciated that some startup data may in some cases not be stored on an auxiliary memory element 300 at all, but rather, only on the tape media.

Augmenting a peripheral memory device may enhance performance as described above. An auxiliary memory element may provide similar advantages and benefits when incorporated into other peripheral memory devices. For example, an auxiliary memory element, as described above, may be incorporated into other removable or non-removable peripheral memory devices. An auxiliary memory element may be integrated with a removable peripheral memory cartridge such as a two-reel tape cassette, a removable magnetic hard drive and the like. An auxiliary memory element may also be incorporated into a CD-ROM drive, a DVD drive, a fix magnetic hard drive, an optical drive, holographic memory drive or other peripheral drive accepting a memory media.

Those skilled in the art will appreciate variations of the above-described embodiments that fall within the scope of the invention. As a result, the invention is not limited to specific examples and illustrations discussed above, but only by the following claims and their equivalents.

1. A cartridge comprising:
a housing adapted to dock with a storage drive;
a storage media mounted in the housing;
a receptacle in the housing, wherein the receptacle is adapted to removably hold an auxiliary memory element; and
an optical interface adapted to provide a data path between the auxiliary memory element and the storage drive.

2. The cartridge of claim 1, wherein the storage media includes a magnetic tape rotatably mounted in the housing.

3. The cartridge of claim 1, further comprising an aperture in the housing positioned to provide access to the receptacle and adapted to allow insertion and removal of the auxiliary memory element.

4. The cartridge of claim 1, further comprising the auxiliary memory element.

5. The cartridge of claim 4, wherein the auxiliary memory element is removable.

6. The cartridge of claim 4, wherein the auxiliary memory element provides memory adapted to store a plurality of thumbnail images.

7. The cartridge of claim 4, wherein the auxiliary memory element provides non-volatile storage.

8. The cartridge of claim 4, wherein the auxiliary memory element comprises a solid-state memory.

9. The cartridge of claim 4, wherein the auxiliary memory element comprises a flash memory.

10. The cartridge of claim 4, wherein the auxiliary memory element comprises a hard drive.

11. The cartridge of claim 1, wherein the auxiliary memory element provides at least 1 MB of memory storage.

12. The cartridge of claim 1, wherein the auxiliary memory element provides at least 10 MB of memory storage.

13. The cartridge of claim 1, wherein the auxiliary memory element provides at least 100 MB of memory storage.

14. The cartridge of claim 1, wherein the auxiliary memory element provides at least 1 GB of memory storage.

15. The cartridge of claim 1, further comprising a second receptacle in the housing adapted to removably hold a second auxiliary memory element.

16. The cartridge of claim 1, further comprising an electrically conductive interface adapted to provide power to the auxiliary memory element.

17. The cartridge of claim 1, wherein the optical interface includes an optical fiber.

18. The cartridge of claim 1, wherein the optical interface includes an infrared interface.

19. A tape cartridge comprising:
a housing;
a magnetic tape rotatably mounted in the housing;
a receptacle in the housing, wherein the receptacle is adapted to removably hold an auxiliary memory element providing at least 1 MB of data storage; and
a physical interface adapted to provide a contact path between the auxiliary memory element and a tape drive.

20. The tape cartridge of claim 19, wherein the physical interface comprises:
a first electrically conductive interface adapted to provide a data path between the auxiliary memory element and the tape drive; and
a second electrically conductive interface adapted to provide power to the auxiliary memory element.

21. A peripheral memory device comprising:
a housing adapted to removably dock with a drive;
a first memory storage media in the housing, wherein the first memory storage media provides primary memory;
a receptacle adapted to removably receive an auxiliary memory element providing secondary memory;
an aperture in the housing adapted to provide a path for inserting and extracting the auxiliary memory element; and
an optical interface adapted to provide a data communication path between the auxiliary memory element and the drive.

22. The peripheral memory device of claim 21, further comprising the auxiliary memory element.

23. The peripheral memory device of claim 21, wherein the first memory storage media is a hard drive.

24. The peripheral memory device of claim 21, wherein the first memory storage media is a two-reel tape cassette.

25. A memory storage system comprising:
a cartridge having
a housing;
a primary memory mounted in the housing;
a receptacle in the housing, wherein the receptacle is adapted to removably hold a removable memory element containing at least 1 MB of data storage;
a drive adapted to removably hold the cartridge; and
a data communications path between the removable memory element and the drive.

26. The memory storage system of claim 25, further comprising the removable memory element.

27. The memory storage system of claim 25, wherein the data communications path comprises an optical fiber interface.

28. A method of writing data to a tape cartridge having a tape media and an auxiliary memory element, the method comprising:
writing information to the tape media;
transforming the information to transformed data, wherein the transformed data occupies less data storage than the information; and
writing the transformed data through an optical interface to the auxiliary memory element.

29. The method of claim 28, wherein:
the act of writing information comprises writing an image to the tape media; and
the act of writing the transformed data comprises writing a thumbnail image of the image to the auxiliary memory element.

30. The method of claim 28, wherein:
the act of writing information comprises writing a video file to the tape media; and
the act of writing the transformed data comprises writing one or more images representative of the video file to the auxiliary memory element.

31. The method of claim 28, further comprising:
writing encryption information to the auxiliary memory element; and
reading encryption information from the auxiliary memory element.

32. The method of claim 28, further comprising:
writing access permission information to the auxiliary memory element; and
reading access permission information from the auxiliary memory element.

33. A method of using a cipher key to process data between a host and a tape cartridge having a tape media and at least one auxiliary memory element, the method comprising:
reading the cipher key from the auxiliary memory element;
reading data from a source;
processing the data with the cipher key; and
writing the processed data to a depository.

34. The method of transferring encrypted data of claim 33, wherein the act of reading the cipher key from the auxiliary memory element includes reading a first part of the cipher key from a first auxiliary memory element and reading a second part of the cipher key from a second auxiliary memory element in the tape cartridge.

35. The method of using the cipher key of claim 33, wherein the source is the host and the depository is the tape media, and wherein the act of processing the data includes encrypting the data from the host to create the processed data.

36. The method of using the cipher key of claim 33, wherein the source is the tape media and the depository is the host, and wherein the act of processing the data includes decrypting the data from the tape media to create the processed data.

37. A method for a drive to initialize a cartridge without instructions from a host, wherein the cartridge has a storage media and an auxiliary memory element, the method comprising:
providing a drive coupled to the host;
inserting the cartridge into the drive;
detecting the cartridge in the drive;
detecting the auxiliary memory element in the cartridge; and
transferring data between the auxiliary memory element and the storage media.

38. The method of claim 37, wherein the act of transferring data comprises:
reading data from the auxiliary memory element; and
writing the data to the storage media.

39. The method of claim 37, wherein the act of transferring data comprises:
reading data from the storage media; and
writing the data to the auxiliary memory element.

40. A cartridge having an optical interface comprising:
an insulator;
a first electrically conductor and a second electrical conductor, wherein the conductors are electrically isolated by the insulator and adapted to provide power; and
an optical interface adapted to provide a data path.

41. The cartridge of claim 40, wherein the optical interface includes an infrared transceiver.

42. The cartridge of claim 40, wherein the optical interface includes an optical fiber core encircled by the first and second electrical conductors.

43. A drive comprising:
a receptacle, wherein the receptacle is adapted to removably hold a cartridge having a storage media and one or more auxiliary memory elements;
a first data interface to read data from and write data to the storage media;
a second data interface to read data from and write data to the one or more auxiliary memory elements, wherein the second data interface is an optical interface;
circuitry to detect a presence of the one or more auxiliary memory elements.
